(19) United States
(12) Patent Application Publication
(10) Pub. No.: US 2024/0023616 A1
(43) Pub. Date: Jan. 25, 2024

(54) A Vapour Generating System

(71) Applicant: JT International SA, Geneva (CH)

(72) Inventor: Herman Hijma, Zwolle (NL)

(73) Assignee: JT International SA, Geneva (CH)

(21) Appl. No.: 18/032,449

(22) PCT Filed: Oct. 15, 2021
(86) PCT No.: PCT/EP2021/078647

§ 371 Date: Apr. 18, 2023

(30) Foreign Application Priority Data
Oct. 23, 2020 (EP) 20203483.1

(51) Int. Cl. A24F 40/46; A24F 40/10; A24F 40/42; A24F 40/44; H05B 3/22

(52) U.S. Cl. CPC A24F 40/46; A24F 40/10; A24F 40/42; A24F 40/44; H05B 3/22

(57) ABSTRACT

A vapour generating system includes a base part including a heating element and a cartridge connectable to the base part. The cartridge includes a liquid store for storing a vapour generating liquid, a vaporization chamber in communication with the liquid store for receiving liquid therefrom, a heat transfer unit configured to transfer heat from the heating element to the chamber to vaporize liquid in the chamber, and a connector for releasably connecting the base part and the cartridge. The connector is configured to apply a connecting force between the base part and the cartridge to urge the heating element and the heat transfer unit into contact with each other. The connector includes a first connecting element on the cartridge and a second connecting element on the base part. The chamber projects from an end of the cartridge and is received in a heater cavity in the base part.

### TECHNICAL FIELD

The present disclosure relates generally to a vapour generating system configured to heat a vapour generating liquid to generate a vapour which cools and condenses to form an aerosol for inhalation by a user of the system. Embodiments of the present disclosure relate in particular to a vapour generating system comprising a reusable base part and a cartridge configured to be used with reusable base part.

### TECHNICAL BACKGROUND

The term vapour generating system (or more commonly electronic cigarette or e-cigarette) refers to a handheld electronic device that is intended to simulate the feeling or experience of smoking tobacco in a traditional cigarette. Electronic cigarettes work by heating a vapour generating liquid to generate a vapour that cools and condenses to form an aerosol which is then inhaled by the user. Accordingly, using e-cigarettes is also sometimes referred to as “vaping”. The vapour generating liquid usually comprises nicotine, propylene glycol, glycerine and flavourings.

Typical e-cigarette vaporizing units, i.e. systems or sub-systems for vaporizing the vapour generating liquid, utilize a cotton wick and heating element to produce vapour from liquid stored in a capsule or tank. When a user operates the e-cigarette, liquid that has soaked into the wick is heated by the heating element, producing a vapour which cools and condenses to form an aerosol which may then be inhaled. To facilitate the ease of use of e-cigarettes, cartridges are often used. These cartridges are often configured as “cartomizers”, which means an integrated component formed from a liquid store (reservoir), a liquid transfer element (e.g. a wick) and a heater. Electrical connectors may also be provided to establish an electrical connection between the heating element and a power source. Such cartridges may be disposable, i.e. not intended to be capable of reuse after the supply of liquid in the reservoir has been exhausted. Alternatively, they may be reusable, being provided with means allowing the reservoir to be refilled with a new supply of vapour generating liquid. Particularly in the case of disposable cartridges, it is desirable to reduce the number and complexity of their components, thereby reducing waste and making the manufacturing process simpler and cheaper.

It has, therefore, been proposed to provide a vapour generating system in which a heating element is integrated into a reusable base part and in which a disposable cartridge is releasably connectable to the base part such that the vapour generating liquid in the reservoir can be heated by the heating element in the base part. Integrating the heating element into the reusable base part allows the cartridge structure to be simplified. There is, however, a need to maximise heat transfer from the heating element in the reusable base part to the vapour generating liquid in the reservoir in the cartridge, and the present disclosure seeks to address this need.

### SUMMARY OF THE DISCLOSURE

According to a first aspect of the present disclosure, there is provided a vapour generating system comprising:
a base part including at least one heating element;
a cartridge releasably connectable to the base part, the cartridge comprising:
   a liquid store for storing a vapour generating liquid, the liquid store including a liquid outlet;
   a vaporization chamber in communication with the liquid outlet for receiving vapour generating liquid from the liquid store;
   a heat transfer unit configured to transfer heat from the heating element to the vaporization chamber to vaporize vapour generating liquid in the vaporization chamber;
a connector for releasably connecting the base part and the cartridge, the connector being configured to apply a connecting force between the base part and the cartridge to urge the at least one heating element and the heat transfer unit into contact with each other.

The base part may include a power supply unit, e.g. a battery, connected to the heating element. In operation, upon activating the vapour generating system, the power supply unit electrically heats the heating element of the base part, which then provides its heat by conduction to the heat transfer unit of the cartridge. The heat transfer unit, in turn, provides the heat to the vaporization chamber, resulting in vaporization of the vapour generating liquid. Vapour created during this process is transferred from the vaporization chamber via a vapour outlet channel in the cartridge so that it can be inhaled by a user of the vapour generating system.

The heat transfer from the heating element in the base part to the heat transfer unit in the cartridge is maximized because the connecting force applied by the connector urges the heating element and the heat transfer unit into contact with each other. The energy efficiency of the vapour generating system is thereby improved.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The connector may be configured to apply the connecting force in a direction substantially parallel to a longitudinal axis of the vapour generating system. This enhances the contact between the heating element and the heat transfer unit, thereby ensuring that heat transfer from the heating element to the heat transfer unit is maximised and thereby maximising energy efficiency.

The connector may comprise a first connecting element on one of the base part and the cartridge and a second connecting element on the other of the base part and the cartridge. The base part and the cartridge can be reliably connected to each other by the first and second connecting elements.

The first and second connecting elements cooperate to provide a releasable connection between the base part and the cartridge. The releasable connection may be a releasable snap-fit connection, a releasable push-fit connection or a releasable press-fit connection. The releasable connection enables the cartridge to be easily detached from the base part after the liquid in the liquid store has been depleted.

The first connecting element may comprise at least one projection and the second connecting element comprise at least one recess. In one example, the at least one projection may extend from the base part and the at least one recess may be formed in a surface of the cartridge. The at least one projection may comprise a resilient snap-hook. The connector can, therefore, be easily formed during manufacture of the base part and the cartridge.

The connector may comprise two of said first connecting elements located oppositely with respect to a longitudinal axis of the vapour generating system and may comprise two of said second connecting elements located oppositely with respect to said longitudinal axis. This arrangement may help to ensure that a uniform connecting force is applied between the base part and the cartridge, and in turn help to ensure that contact between the heating element and the heat transfer unit is optimised.

The vaporization chamber may project from an end of the cartridge, e.g. a distal end of the cartridge, and may be received in a corresponding heater cavity in the base part. The projecting vaporization chamber constitutes the first connecting element and the recess constitutes the second connecting element. For example, the vaporization chamber may be dome-shaped or cone-shaped. The vaporization chamber may comprise a truncated dome (i.e., may be frustodomal) or may comprise a truncated cone (i.e., may be frustoconical). The first connecting element may comprise a ridge and the second connecting element may comprise a recess. The ridge may be an annular ridge and the recess may be an annular recess. Other shapes are, however, possible. For example, the ridge and recess may be polygonal, such as square or rectangular, or may be oval. The vaporization chamber and heat transfer unit are, thus, positioned ‘externally’ at an end of the cartridge. This may allow the volume of the liquid store to be maximised and a cleaner/flatter contour inside the liquid store which reduces the likelihood of vapour generating liquid becoming trapped. This may also ensure that heat transfer to the vapour generating liquid in the liquid store from the heat transfer unit and/or the heating element of the base part are minimised because these components are positioned further away from the liquid store. Energy efficiency is thereby further improved, because the vapour generating liquid in the liquid store is not subjected to excessive heating by stray heat from the heat transfer unit and/or the heating element.

The annular ridge may extend around an outer surface of the vaporization chamber and the annular recess may extend around an inner surface of the heater cavity. This may help to ensure that a uniform connecting force is applied between the base part and the cartridge, thus ensuring that contact between the heating element and the heat transfer unit is optimised.

The vapour generating system may further comprise a sorption member at least partially disposed within the vaporization chamber for absorbing vapour generating liquid from the liquid store via the liquid outlet. The heat transfer unit may contact the sorption member to heat the sorption member and vaporize the absorbed vapour generating liquid. This is a continuous process, in which vapour generating liquid from the liquid store is continuously absorbed by the sorption member. As noted above, vapour created during this process is transferred from the vaporization chamber via a vapour outlet channel in the cartridge so that it can be inhaled by a user of the vapour generating system.

The vapour generating liquid may comprise polyhydric alcohols and mixtures thereof such as glycerine or propylene glycol. The vapour generating liquid may contain nicotine and may, therefore, be designated a nicotine-containing liquid. The vapour generating liquid may contain one or more additives, such as a flavouring.

The sorption member can be made of any material or a combination of materials being able to perform sorption and/or absorption of another material, and can be made, for example, of one or more of the following materials: fibre, glass, aluminium, cotton, ceramic, cellulose, glass fibre wick, stainless steel mesh, polyethylene (PE), polypropylene, polyethylene terephthalate (PET), poly(cyclohexanedimethylene terephthalate) (PCT), polybutylene terephthalate (PBT), polytetrafluoroethylene (PTFE), expanded polytetrafluoroethylene (ePTFE), and BAREX®, etc.

The heat transfer unit may comprise a thermally conductive material, for example, a metal such as aluminium, copper, etc.

The heating element may comprise an electrically resistive material. The heating element may include a ceramic material, for example tungsten and alloys thereof. The use of a ceramic material conveniently helps to rigidify the heating element. The heating element may be at least partially encapsulated in, or coated with, a protective material, such as glass.

The heating element may be formed using a metal having a defined relationship between temperature and resistivity. In such embodiments, the metal may be formed as a track between two layers of suitable insulating materials. A heating element formed in this manner may be used both as a heater and a temperature sensor.

The heating element may include a temperature sensor embedded therein or attached thereto.

The power supply unit, e.g. battery, may be a DC voltage source. For example, the power supply unit may be a Nickel-metal hydride battery, a Nickel cadmium battery, or a Lithium based battery, for example a Lithium-Cobalt, a Lithium-Iron-Phosphate, a Lithium-Ion or a Lithium-Polymer battery.

The base part may further comprise a processor associated with electrical components of the vapour generating system, including the battery.

The cartridge may further comprise: a cartridge housing at least partially including the liquid store and the vaporization chamber, and a vapour outlet channel extending along the cartridge housing and in fluid communication with the vaporization chamber. The cartridge housing may have a proximal end configured as a mouthpiece end which is in fluid communication with the vaporization chamber via the vapour outlet channel and a distal end associated with the heat transfer unit. The mouthpiece end may be configured for providing the vaporized liquid to the user. The heat transfer unit may be disposed at the distal end. The heat transfer unit may be substantially perpendicular to the vapour outlet channel.

The liquid store may be juxtaposed with the vapour outlet channel extending between the vaporization chamber and the mouthpiece end. The liquid store may be disposed around the vapour outlet channel.

The cartridge housing may be made of one or more of the following materials: aluminium, polyether ether ketone (PEEK), polyimides, such as Kapton®, polyethylene terephthalate (PET), polyethylene (PE), high-density polyethylene (HDPE), polypropylene (PP), polystyrene (PS), fluorinated ethylene propylene (FEP), polytetrafluoroethylene (PTFE), polyoxymethylene (POM), polybutylene terephthalate (PBT), Acrylonitrile butadiene styrene (ABS), Polycarbonates (PC), epoxy resins, polyurethane resins and vinyl resins.

### BRIEF DESCRIPTION OF THE DRAWINGS

FIG. 1 is a schematic view of a vapour generating system comprising a base part and a cartridge;

FIG. 2 is a perspective view of a first example of a cartridge;

FIG. 3 is a cross-sectional view of the cartridge shown in FIG. 2;

FIG. 4 is a side view of a vapour generating system comprising a base part and the cartridge shown in FIGS. 2 and 3 connected to the base part;

FIG. 5 is a perspective view of a second example of a cartridge; and

FIG. 6 is a side view of a vapour generating system comprising a base part and a third example of a cartridge connected to the base part.

### DETAILED DESCRIPTION OF EMBODIMENTS

Embodiments of the present disclosure will now be described by way of example only and with reference to the accompanying drawings.

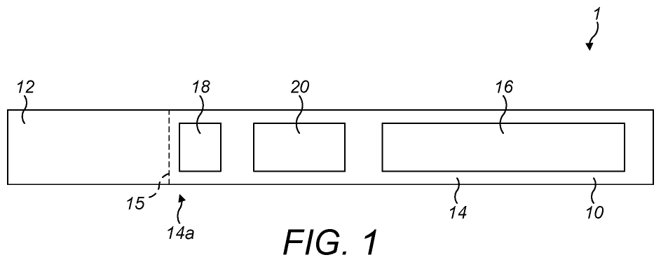

Referring initially to FIG. 1, there is shown schematically a vapour generating system 1 for vaporizing a vapour generating liquid to generate a vapour (or aerosol) for inhalation by a user of the system 1. The vapour generating system 1 comprises a base part 10 and a cartridge 12 thermically connected to the base part 10. The base part 10 is thus the main body part of the vapour generating system 1 and is preferably re-usable.

The base part 12 comprises a housing 14 accommodating a power supply unit in the form of a battery 16 connected to a resistive heating element 18 located at a first end 14a of the housing 14. The first end 14a of the housing 14 has an interface 15 configured for matching a corresponding interface of the cartridge 12. The battery 16 is configured for providing the heating element 18 with the necessary electrical power for its operation, allowing it to become heated to a required temperature. The battery 16 is also connected to a processor 20, enabling the required power supply for its operation. The processor 20 is connected to the heating element 18 and controls its operation.

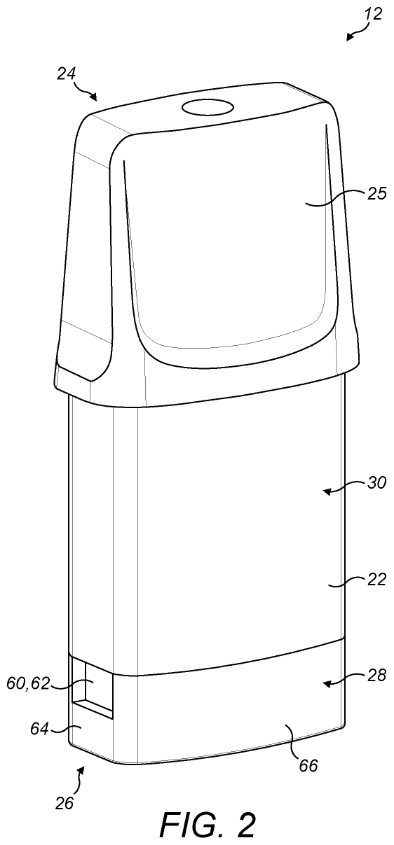

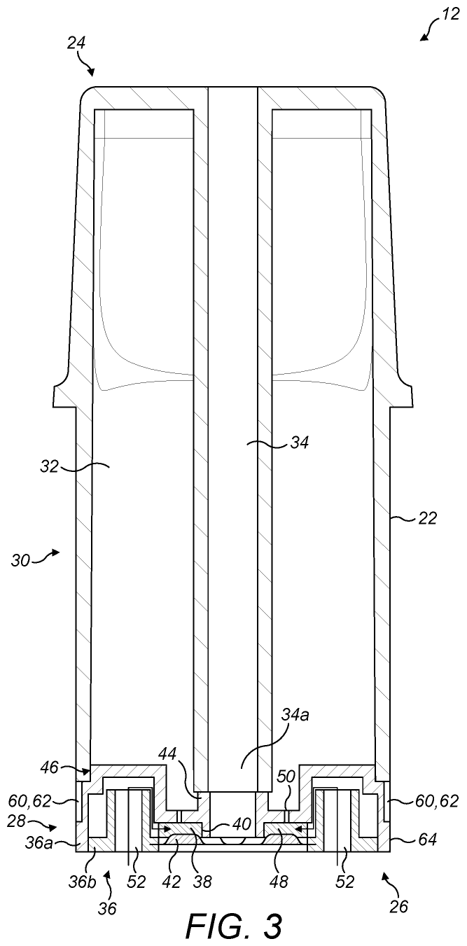

Referring additionally to FIGS. 2 and 3, in a first example the cartridge 12 comprises a cartridge housing 22 having a proximal end 24 and a distal end 26. The proximal end 24 may constitute a mouthpiece end configured for being introduced directly into a user's mouth and may, therefore, also be designated as the mouth end 24. In some embodiments, a mouthpiece 25 may be fitted to the proximal end 24 as shown in FIG. 2.

The cartridge 12 comprises a base portion 28 and a liquid storage portion 30. The liquid storage portion 30 comprises a liquid store 32, configured for containing therein a vapour generating liquid, and a vapour outlet channel 34. The vapour generating liquid may comprise an aerosol-forming substance such as propylene glycol and/or glycerol and may contain other substances such as nicotine and acids. The vapour generating liquid may also comprise flavourings such as, e.g., tobacco, menthol, or fruit flavour. The liquid store 32 may extend generally between the proximal end 24 and the distal end 26, but is spaced from the distal end 26. The liquid store 32 may surround, and coextend with, the vapour outlet channel 34.

As best seen in FIG. 3, the base portion 28 of the cartridge 12 may be configured to sealingly close off the distal end 26 of the cartridge 12. The base portion 28 comprises a plug assembly 36 comprising first and second plug members 36a, 36b, a ring shaped sorption member 38 having a centrally positioned hole 40, and a heat transfer unit 42 which are all positioned at the distal end 26 of the cartridge housing 22, and more particularly in the space formed between the liquid store 32 and the distal end 26. The plug assembly 36, and more specifically the first plug member 36a, closes the distal end 26 of the cartridge housing 22 and thereby retains the vapour generating liquid in the liquid store 32.

The first plug member 36a is provided with a circumferential surface 46 that is in contact with the inner circumferential surface of the liquid store 32. The first plug member 36a may be formed of a material with an elasticity that provides a sealing effect when the circumferential surface 46 contacts the inner circumferential surface of the liquid store 32. For example, the first plug member 32a may comprise rubber or silicone. Alternatively, the first plug member 36a may comprise a thermoplastic material which enables the first plug member 36a and the liquid store 32 to be joined together by, e.g., ultrasonic welding. The first plug member 36a comprises a connecting portion 44 which is configured to sealingly connect to a distal end 34a of the vapour outlet channel 34 as shown in FIG. 3.

The cartridge 12 includes a vaporization chamber 48 defined between the first plug member 36a and the heat transfer unit 42. The sorption member 38 is positioned in the vaporization chamber 48. The first plug member 36a includes a plurality of circumferentially spaced liquid outlets 50 which provide a controlled flow of vapour generating liquid from the liquid store 32 to the sorption member 38 positioned in the vaporization chamber 48 adjacent to the liquid outlets 50.

The sorption member 38 is positioned in the vaporization chamber 48 between the liquid outlets 50 and the heat transfer unit 42. The sorption member 38 is configured, on the one hand, for absorbing therein some of the vapour generating liquid from the liquid store 32, and, on the other hand, for being heated by the heat transfer unit 42 thereby allowing the vapour generating liquid absorbed therein to be vaporized in the vaporization chamber 48.

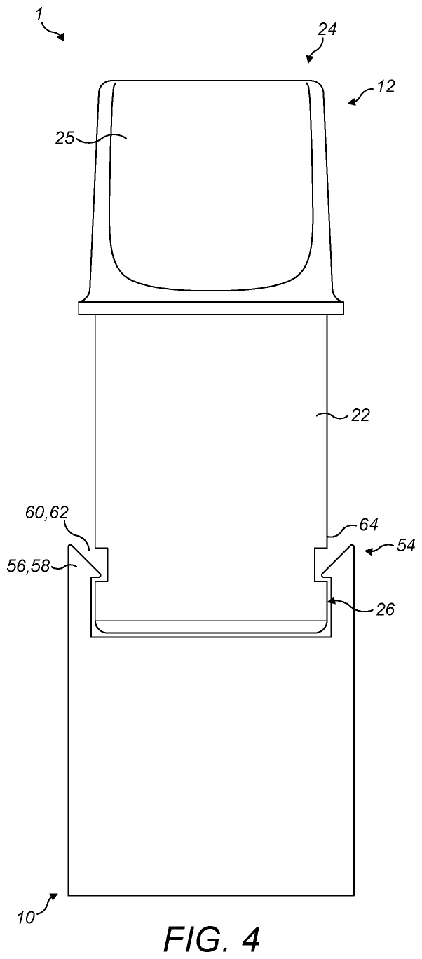

When the base part 10 and the cartridge 12 are assembled together as shown in FIGS. 1 and 4, the heating element 18 of the base part 10 contacts the heat transfer unit 42 of the cartridge 12, such that the cartridge 12 is thermically connected to the base part 10. In operation, the heating element 18 is resistively heated by the power from the battery 16 and provides its heat to the heat transfer unit 42 via conduction. The heat from the heat transfer unit 42 is then transferred to the sorption member 38, mainly by conduction. Thus, the sorption member 38 is heated indirectly by the heat transfer unit 42, and not directly by the heating element 18 of the base part 10. The heating element 18 in the base part 12 ideally needs to attain a temperature of around 500° C. in order to transfer enough heat such that the interface between the sorption member 38 and the heat transfer unit 42 reaches a temperature at which vaporization occurs (typically between 200° C. and 250° C.). As a result of heating of the sorption member 38, the vapour generating liquid absorbed therein from the liquid store 32 is vaporized in the vaporization chamber 48, and the vapour escapes from the vaporization chamber 48 via the vapour outlet channel 34 when a user sucks on the proximal (mouth) end 24 of the cartridge 12. The vapour cools and condenses as it flows through the vapour outlet channel 34 to form an aerosol that can be inhaled by a user via the proximal (mouth) end 24.

The cartridge 12 includes air inlets 52 to allow air to flow to the vaporization chamber 48 during use of the vapour generating system 1 when a user sucks on the proximal (mouth) end 24 of the cartridge 12 as described above. In the illustrated example, the air inlets 52 are formed in the second plug member 36b and allow air to flow to the vaporization chamber 48 along a path formed between the first and second plug members 36a, 36b as shown in FIG. 3. Other configurations are, however, entirely within the scope of the present disclosure.

Referring to FIG. 4, the vapour generating system 1 comprises a connector 54 for releasably connecting the base part 10 and the cartridge 12. In the illustrated example, the connector 54 comprises a pair of first connecting elements 56 in the form of resilient snap-hooks 58 formed integrally with the base part 10 and pair of second connecting elements 60 in the form of recesses 62 formed in side surfaces 64 of the cartridge housing 22 towards the distal end 26. When the base part 10 and the cartridge 12 are connected as shown in FIG. 4, the cooperation between the resilient snap-hooks 58 and the recesses 62 applies a connecting force between the base part 10 and the cartridge 12 in a direction substantially parallel to a longitudinal axis of the vapour generating system 1. The connecting force has a sufficient magnitude to urge (i.e., physically pull) the base part 10 and the cartridge 12 together, and thereby to urge the heating element 18 and the heat transfer unit 42 into contact with each other. The connection between the base part 10 and the cartridge 12 that is provided by the resilient snap-hooks 58 and the recesses 62 is releasable, in the sense that the resilient snap-hooks 58 can be released from the recesses 62 upon suitable manipulation by a user. Thus, a used cartridge 12 in which the vapour generating liquid has been depleted from the liquid store 32 can be removed to allow a replacement cartridge 12 to be connected to the base part 10.

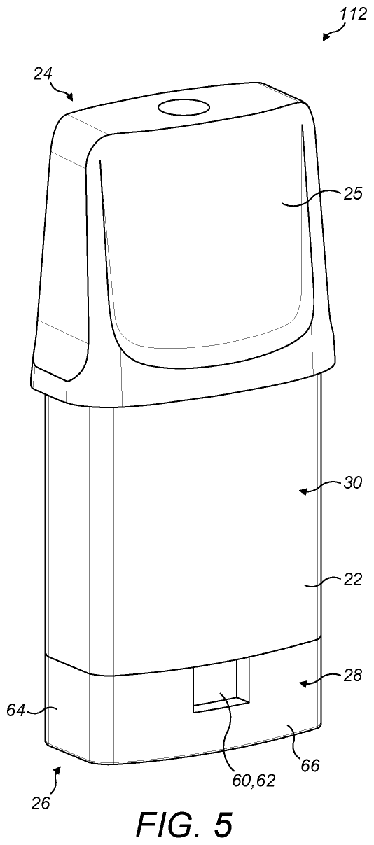

FIG. 5 illustrates a second example of a cartridge 112 which is similar to the cartridge 12 described above and in which corresponding components are identified using the same reference numerals. In the second example of the cartridge 112, the recesses 62 (i.e., second connecting elements 60) are formed in major surfaces 66 of the cartridge housing 22 towards the distal end 26 and are configured for engagement by suitably positioned resilient snap-hooks 58 (i.e., first connecting elements 56) on the base part 10. In all other respects, the cartridge 112 is the same as the cartridge 12 described above.

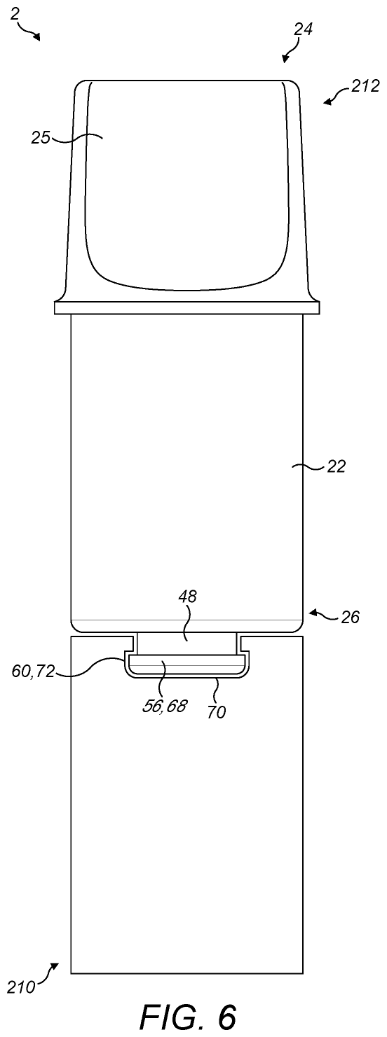

Referring now to FIG. 6, there is shown a vapour generating system 2 comprising a third example of a cartridge 212 connected to a base part 210. The cartridge 212 and base part 210 are similar to the cartridge 12 and base part 10 described above with reference to FIGS. 1 to 4 and corresponding components are identified using the same reference numerals.

The cartridge 212 is configured so that the vaporization chamber 48, containing both the sorption member 38 and the heat transfer unit 42 (neither of which are visible in FIG. 6), projects from the distal end 26 of the cartridge 212. An annular ridge 68 extends around an outer surface of the vaporization chamber 48 and constitutes the first connecting element 56. The base part 210 includes a heater cavity 70 in which the vaporization chamber 48 is received when the base part 210 and the cartridge 212 are connected, and an annular recess 72 which constitutes the second connecting element 60 extends around an inner surface of the heater cavity 70. When the cartridge 212 is connected to the base part 210, the annular ridge 68 cooperates with the annular recess 72 to provide a secure connection between the cartridge 212 and the base part 210 and to apply a connecting force between the base part 210 and the cartridge 212 in a direction substantially parallel to a longitudinal axis of the vapour generating system 2. As discussed above, the connecting force has a sufficient magnitude to urge the heating element 18 and the heat transfer unit 42 into contact with each other.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A vapour generating system comprising:
a base part including at least one heating element;
a cartridge releasably connectable to the base part, the cartridge comprising:
a liquid store for storing a vapour generating liquid, the liquid store including a liquid outlet;
a vaporization chamber in communication with the liquid outlet for receiving vapour generating liquid from the liquid store;
a heat transfer unit configured to transfer heat from the heating element to the vaporization chamber to vaporize vapour generating liquid in the vaporization chamber; and
a connector for releasably connecting the base part and the cartridge, the connector configured to apply a connecting force between the base part and the cartridge to urge the at least one heating element and the heat transfer unit into contact with each other;
wherein the connector comprises a first connecting element on the cartridge and a second connecting element on the base part, and the vaporization chamber projects from an end of the cartridge and is received in a corresponding heater cavity in the base part.

2. The vapour generating system according to claim 1, wherein the connector is configured to apply the connecting force in a direction substantially parallel to a longitudinal axis of the vapour generating system.

3. The vapour generating system according to claim 1, wherein the first and second connecting elements cooperate to provide a releasable connection between the base part and the cartridge.

4. The vapour generating system according to claim 1, wherein an annular ridge extends around an outer surface of the vaporization chamber and an annular recess extends around an inner surface of the heater cavity.

5. The vapour generating system according to claim 1, further comprising a sorption member at least partially disposed within the vaporization chamber for absorbing vapour generating liquid from the liquid store via the liquid outlet, wherein the heat transfer unit contacts the sorption member to vaporize the absorbed vapour generating liquid.

6. The vapour generating system according to claim 1, wherein the first connecting element comprises a ridge and the second connecting element comprises a recess.

7. The vapour generating system according to claim 6, wherein the ridge is an annular ridge and the recess is an annular recess.

8. The vapour generating system according to claim 1, wherein the base part includes a power supply unit connected to the heating element.

9. The vapour generating system according to claim 1, wherein the heat transfer unit comprises a thermally conductive material.

10. The vapour generating system according to claim 1, wherein the cartridge further comprises a cartridge housing at least partially including the liquid store and the vaporization chamber, and a vapour outlet channel extending along the cartridge housing and in fluid communication with the vaporization chamber.

11. The vapour generating system according to claim 10, wherein the cartridge housing has a proximal end configured as a mouthpiece end which is in fluid communication with the vaporization chamber via the vapour outlet channel and a distal end associated with the heat transfer unit.

12. The vapour generating system according to claim 11, wherein the heat transfer unit is disposed at the distal end substantially perpendicular to the vapour outlet channel.

13. The vapour generating system according to claim 10, wherein the liquid store is disposed around the vapour outlet channel.
